(19) United States
(12) Patent Application Publication
(10) Pub. No.: US 2014/0279575 A1
(43) Pub. Date: Sep. 18, 2014

(54) METHOD FOR CALCULATING EFFECTS ON CAR HIRE

(71) Applicant: Greenbrier Management Services, LLC, Lake Oswego, OR (US)

(72) Inventor: Gary Edward BRANDT, Portland, OR (US)

(21) Appl. No.: 14/213,054

(22) Filed: Mar. 14, 2014

Related U.S. Application Data
(60) Provisional application No. 61/798,444, filed on Mar. 15, 2013.

(51) Int. Cl. G06Q 30/06; G06Q 50/30

(52) U.S. Cl. CPC G06Q 30/0645; G06Q 50/30
USPC 705/307

(57) ABSTRACT

Systems and methods for statistically analyzing effects on car hire.

### CROSS-REFERENCE TO RELATED APPLICATIONS

This application claims the benefit of priority to U.S. Provisional Application No. 61/798,444 filed on Mar. 15, 2013.

### BACKGROUND OF THE INVENTION

Railroad transport equipment is typically expensive. For example, the per-unit cost of a railroad car may range from between $50,000 to $250,000, depending on the type and design of the car. Specific examples of railroad transport equipment might include railroad cars, intermodal containers such as ocean and other shipping containers that are placed either on flat cars or specially constructed well cars for ground transport, and transport appurtenance, such as racks, inserted into rail cars to support automobiles. This list is not intended to be exhaustive. Though many different owners of railroad transport equipment build and/or purchase their own individual units, those units mostly operate over the same network of railroad track as do units owned by other entities. Accordingly, it would be very inefficient for each railroad transport company, such as a railroad, to transport cargo using only its own equipment. Instead, in order to increase the efficient utilization of resources, the railroad industry in North America shares railroad transport equipment. In other words, a railroad transport company, when transporting cargo on behalf of a customer, may utilize any transport equipment available, irrespective of who owns that equipment. Essentially, this means that the owner of a railroad car or other type of transport equipment will simply release the equipment into commerce, and be compensated for another's use of that equipment as it is used. Such compensation is known in the industry as “car hire.”

Generally speaking, from the perspective of a railroad transport company using another's railroad transport equipment, there are four types of transport equipment owners to be potentially compensated. Foreign railroads are competing railroads that own shared transport equipment. Private equipment owners build and/or purchase shared equipment, but do not own any physical track on the shared network. TTX (or Trailer Train Company) is a company specifically formed to provide transport equipment and management services to North American railroads, and is owned by North America's leading railroad companies, each of which has stock in TTX. Finally, intermodal equipment owners provide equipment other than rail cars that are used when transporting cargo, such as ocean containers and the like. Compensation made to these owners for the use of their respective pieces of transport equipment is negotiated, and varies not only by the type of owner, but also by the value, age, size, etc. of the specific equipment used.

The importance of accurate car hire calculations cannot be overstated. According to industry estimates, over $3 billion is spent annually to compensate owners of transport equipment, and is considered to be the third highest operating cost of individual railroads, behind labor and fuel. In terms of volume, over two million pieces of registered transport equipment are available for shared use, and for which compensation must be calculated.

From a management perspective, accounting for the car hire amounts owed among operators and owners is a daunting task, not only for the sheer number of units involved—which can be as high as tens of thousands of pieces of equipment used by a railroad in a given month—but also because individual units change hands so frequently. To facilitate both the accurate and uniform calculation of car hire, or amounts owed to equipment owners, a company called RailInc maintains a database of movements of transport equipment. This database is called the Telerail Automated Information Network (TRAIN II) and records both a unique identifier for each shared unit of transportation equipment along with interchange information recording where and when specific transport units are transferred between users. From this information, accurate records of who is using what equipment, for what periods of time, and for how many miles, can in theory be maintained. Furthermore, most rates charged for available pieces of transport equipment are maintained in a Car Hire Accounting Rate Master (CHARM) file. Though the information in these databases is accessible by both the users of the equipment and the owners of the equipment, it is the responsibility of the users (the transporters) to calculate the amount of car hire they owe to each respective owner whose equipment was used in a given month.

Conceptually, the calculation of car hire owed to an owner by a transporter should be a simple process. Car hire rates are applied on both a per-hour basis (or in the case of intermodal equipment, a per day basis) and a per-mile basis. In other words, the amount of car hire owed is the sum of a negotiated hourly rate multiplied by the hours used, and a negotiated mileage rate multiplied by the number of miles the transporter moved the applicable transport unit. Once the time and mileage start and end points are deduced from the RailInc database, a net amount owed for use of the unit can be calculated.

In practice, however, several factors complicate this computation. First, each railroad transport company must update interchange information with RailInc in a timely manner. Unfortunately, many such companies are not as meticulous as would be ideal, and interchange gaps in RailInc's database commonly occur. To address this issue, the North American railroad industry has developed an automated process called LCS (Liability Continuity System) that analyzes the data from TRAIN II, identifies missing interchange information, and assigns appropriate liability. Specifically, each railroad transporter is required to report an interchange within 120 hours of its occurrence. Each night, the LCS system analyzes reportings that are older than 120 hours and creates LCS messages for transport equipment. If one party to an equipment interchange does not report, the information provided by the other party is used. If neither party reports, LCS attempts to create continuity by analyzing the next three reported moves.

More problematic to the accurate computation of car hire amounts owed are reclaims. Reclaims are offsets to amounts of car hire owed, and are either specifically defined in uniform car hire rules adopted by the rail industry, or are specifically negotiated among parties. As one example, Car Hire Rule 22 allows for a reclaim if an empty car does not move due to the loading station being full, closed etc. As another example, two parties may negotiate special reclaims that permit 120 free hours a month. As a third example, a negotiated reclaim may reduce either, or both, the per-mile rate or the per-hour rate for specific cars, types of commodities transported, etc. While the computation of a base car hire amount is straightforward, the computation of any offsetting reclaims can be complicated, not only computationally due to the varying types of reclaims, but also administratively because often the only party documenting the reclaim is the transporter, making verification by the owner somewhat difficult. Accordingly, existing car hire calculation systems limit themselves to the application of a single reclaim per piece of equipment at any given time, and also require that the transporter document any desired reclaim at the time an interchange is reported, using a code specific to the reclaim being asserted. For example, when transporter X reports acquiring equipment Y at point A and time B and releasing the equipment at point C and time D, the transporter will enter a single applicable reclaim code for that movement. In this manner, the code can be used to calculate the applicable offset against amounts owed for the use of the equipment, and is documented contemporaneously with the movement of the equipment for verification by the equipment owner.

Using information from the respective TRAIN II, CHARM, and LCS systems, net amounts of car hire owed are calculated by transporters and reported back to RailInc by the 40^{th} day following the month being calculated. Almost all Class I railroads, defined as those having annual operating revenues at or above $50 million (in 1978 dollars), and including BNSF, CN, UP and others, use their own proprietary systems. Similarly, two Class II railroads, defined as railroads with annual operating revenues between $10 million and $50 million (again in 1978 dollars) also use proprietary systems. Most of the remaining railroads pay third parties to calculate the amount of car hire they owe. Such third parties include Railcar Management Inc. (RMI) and Intellitrans, LLC.

Both the proprietary and third party payables systems mentioned above are not as accurate as is desired. Specifically, they tend to undervalue the amount of reclaims applicable to car hire, and therefore lead railroads to pay more car hire than is warranted. This occurs primarily for two reasons. First, each system can only apply a single reclaim to each car possession. Second, an operator may inadvertently omit entering a reclaim mode or may mistype the reclaim mode causing the reclaim to be invalidated. In either instance, an applicable reclaim is never applied, costing the railroad money.

What is desired, therefore, is an improved payables system for calculating the amount of car hire owed by a railroad transporter to an owner of transport equipment.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 shows an exemplary payables system disclosed in the present application that uses data received from a customer and third party databases to produce car hire payables reports on behalf of the customer.

FIG. 2 shows a summary of a process that the payables system of FIG. 1 may use to generate the car hire payables reports.

FIG. 3 shows in more detail the initial car hire computation of FIG. 2

FIG. 4 shows a novel reclaims queue used by the reclaims computation module of FIG. 2.

FIG. 5 shows an exemplary summary process used by reclaims computation module shown in FIG. 2.

FIG. 6 shows in more detail the preliminary processing module of FIG. 5.

FIG. 7 shows in more detail rate reclaim module of FIG. 5.

FIG. 8 shows in more detail the “fixed time” reclaim module of FIG. 5.

FIG. 9 shows in more detail the “up to” reclaim module of FIG. 5.

FIG. 10 shows a system that determines the effects on car hire of specified operational components.

FIG. 11 illustrates a method implemented by the system of FIG. 10.

### DETAILED DESCRIPTION OF PREFERRED EMBODIMENT

In this specification, the term “railroad” should be understood to encompass any entity engaged in the commercial transport of cargo over railroad track using railroad transport equipment. In addition, the following terms will be accorded the meanings that respectively follow them, which should be understood by those familiar with the art. These meanings are provided to facilitate understanding of the specification by those unskilled in the art, as well. The disclosed systems for calculating car hire may preferably be used in North America, which has adopted a standardized car hire calculation methodology with relatively esoteric rules and pre-existing databases/computer systems that may interact with the disclosed system specifically described herein. However, to the extent that the aforementioned rules may change, or that similar car hire systems are adopted elsewhere in the world, the disclosed system may be modified to accommodate such variances, and the use of the following specific terminology does not limit the scope of the subject matter claimed.

Accounting Month: The month for which the disclosed payables system is currently computing amounts due. Because a railroad in North America is given a month and 10 days to report payables data to RailInc, this is most likely the month prior to the actual date on which the payables system is currently processing.

Actual Route-Mileage: The calculation of mileage, to which a mileage rate applies, along the actual route a piece of transport equipment traveled during a possession. Actual-Route is distinguished from Short Route Mileage.

Car Hire: The requirement that a railroad reports to an owner of transport equipment for the use of that equipment. Examples of such transport equipment include, but are not limited to, rail cars, intermodal equipment, and appurtenances. The term “car hire amount” refers to the net amount owed an owner for use of a unit or piece of transport equipment. The term “initial car hire amount” is used to refer to an preliminary amount owed prior to any reclaims being applied against that initial car hire amount.

Car Hire Accounting Rate Master (CHARM): The official source of time and mileage rates on freight cars, CHARM contains rates effective for a current month, and is updated monthly. CHARM rates include both default rates for freight cars and special negotiated rates dependent on defined circumstances.

Centralized Station Master File (CSM): A geographic location Industry Reference File (IRF) containing data about rail and motor carrier points for North America and international areas used by railroads to help plan freight movements from origin to destination in an efficient and timely manner. CSM rail station records are uniquely identified by a combination of a Standard Carrier Alpha Code (SCAC) field and Freight Station Accounting Code (FSAC). In addition, CSM stations can be uniquely identified by their respective Standard Point Location Code (SPLC).

Claim: The method by which a transport equipment owner notifies a railroad of a belief that they have been underpaid by the owner.

Customer Identification File (CIF): An IRF that contains the name, physical and mailing addresses, corporate parent identification, and a unique identification code for each location of a transportation carrier customer used in exchanges of information. The purpose of the CIF is to accurately identify transportation company customers and the customers' respective locations.

Cycle: A logical grouping of events and movements that would be rated and reported as a unit.

Equipment Mark: A unique identifier for a piece of railroad or intermodal equipment, consisting of a two to four letter identifier followed by a number up to six digits long, i.e. ABCD 123456. Sometimes used interchangeably with the term Equipment Number, but sometimes merely referring to the two to four letter identifier.

Equipment Number: A unique identifier for a piece of railroad or intermodal equipment, consisting of a two to four letter identifier followed by a number up to six digits long, i.e. ABCD 123456. Sometimes used interchangeably with the term Equipment Mark, but sometimes merely referring to the six digit number.

Freight Station Accounting Code: A carrier-assigned unique number for every station that initiates billing.

Industry Reference File (IRF): File representations of standardized data maintained by Railnc and distributed to the North Americal Railroad Industry. Files include the Customer Identification File (CIF), Mark Register File (MARK) Route File (ROUTE), Shipment Conditions File (SCF), Serving Carrier/Reciprocal Switch (SCRS) File, Centralized Station Master File (CSM) and the Standardized Transportation Commodity Code (STCC) File.

Liability Continuity System (LCS): Developed to create the official interchange record for car hire settlement, LCS analyzes event data from TRAIN II to establish continuity among equipment interchanges, using default records when necessary. LCS was developed so that car hire calculations could be made more accurately.

Mark Owner: The registered owner of a piece of railroad transport equipment identified by an equipment mark, and to whom car hire may be owed.

Mark Register File (MARK): An IRF containing the SCAC abbreviation, the full name and accounting rule 260 number, if a railroad, of a transporter of railroad transport equipment.

Possession: The interim between successive equipment interchanges that a railroad has use of a piece of Railroad Transport Equipment during an accounting month. A possession begins either at the interchange where a railroad acquires use of the equipment or the beginning of the accounting month where possession is carried over from a previous accounting month. A possession ends either at the interchange where the railroad transfers use of the equipment during the accounting month or at the end of the calendar month if the possession carries over until the next calendar month.

RailInc: A wholly owned subsidiary of the Association of American Railroads providing information technology and related services to North America's railroads.

Railroad Transport Equipment: Equipment used to move cargo over railroad tracks. Specific examples include, but are not limited to, rail cars, cargo containers placed on rail cars, and appurtenances such as automobile racks attached to rail cars.

Reclaim: An offset to amounts owed to an owner of railroad transport equipment for the use of that equipment.

Short Route Mileage (SRM): The application of mileage based on the shortest route between two points, regardless of the actual route the equipment took.

Standard Carrier Alpha Code (SCAC): A unique two to four letter code used to identify transportation companies.

Standard Transportation Commodity Code File (STCC): An IRF including a 7-digit numeric industry-defined code that describes a commodity carried by railroad transport equipment, and used on waybills and other shipping documents.

Standard Point Location Code (SPLC): A six to nine digit numeric code assigned to a railroad station to specify the physical location of the station.

Telerail Automated Information Network (TRAIN II): A system that provides physical location information of North American rail equipment as reported by over 330 railroads.

Transfer of Liability (TOL): Introduced in 1994, TOL allows a delivering carrier to transfer responsibility for car hire to a receiving carrier when that carrier cannot accept cars at interchange.

Universal Machine Language Equipment Register (UMLER): A national database hosted by Railinc that contains codes for specific details on individual pieces of equipment, such as internal and external dimensions, carrying capacities, and equipment weight for freight cars.

Waybill: A paper or electronic document for handling and accounting for a shipment of freight.

In addition to the foregoing definitions, a preliminary discussion of reclaims would be helpful to understanding the following disclosure. As stated earlier, a reclaim is an offset to an amount otherwise owed for the use of another's rail transport equipment. Some reclaims are standardized and set out in Car Hire rules adopted by the North American Railroad industry. For example, a standardized reclaim may provide that no car hire is owed for time that damaged equipment is being repaired in a shop, for time and mileage spent when the equipment itself is the freight (being transported, e.g. from the manufacturer or to a repair shop), for time spent waiting to be loaded, etc. Other reclaims are negotiated, and may typically be quite specific. For example, a reclaim may be negotiated between an owner and a railroad that reduces the time and/or mileage rate for a particular type of equipment, equipment over or under a certain weight, equipment carrying certain cargo, etc. Furthermore, some negotiated reclaims provide particular customers with an amount of time “up to” which no car hire accrues for either specific pieces of equipment, or more particularly any equipment of the owner's that a railroad uses.

Although there are myriad variations of reclaims, they may be generally categorized into three groups—rate reclaims, “fixed time” reclaims, and “up to” reclaims. A rate reclaim is a special negotiated rate, either time or mileage, afforded to a railroad that uses a given piece of equipment to which the special rate applies. As stated earlier, the rate reclaim may depend on what equipment is used, what cargo is being carried, where it is being moved, etc., or even a combination of these factors. A “fixed time” reclaim is a reclaim that has determinable, fixed, beginning and end points. For example, standardized reclaims for time a piece of equipment is held short of loading is an example of a “fixed time” reclaim because it applies between the fixed time of when the equipment arrives to be loaded and the time it actually begins to be loaded. A characteristic of a fixed time reclaim is that it offsets the entire car hire amounts otherwise owed during the applicable time. Thus, using the foregoing example, while a car is being held short of loading, neither a time rate nor a mileage rate is applied. Finally, “up to” reclaims allow a railroad the free use of equipment for “up to” a negotiated amount of time.

Referring to FIGS. 1 and 2, an exemplary payables system 10 may be interconnected to exemplary data inputs and outputs 12, 14, and 16. For example, the described payables system 10 receives input data 24 from Railinc 12, TTX 14, and one or more customers 16, and outputs a report 28 to Railinc 12 and a report 26 to the one or more customers from whom input 16 is received. The reports 26 and 28 may be identical or may differ from each other, however the report 28 preferably includes all data a railroad is required to submit to Railinc as part of its monthly reporting obligation. The payables system 10 may preferably be interconnected with the inputs and outputs 12, 14, and 16 through the Internet or other appropriate connection, such as a LAN, capable of transferring data to and from the payables system 10. Alternative payables systems may exclude one or more of the delineated interconnected inputs and outputs, or alternatively include more inputs or outputs than those shown in FIG. 1.

The payables system 10 is intended to calculate car hire amounts on behalf of a customer 16, who in turn is obligated to both report amounts owed to Railinc 12 and pay the amounts due. The calculated car hire amount will typically include two components—an initial car hire amount and a reclaim amount. The initial car hire amount for a car is calculated by an initial car hire module 18 as the sum of a mileage rate applied over miles traveled during a possession, and an hourly rate applied over the duration of a possession. For intermodal equipment, only a daily rate is applied rather than hours and miles. The reclaim amount, which is an offset against the initial car hire amount, is calculated by a reclaims application module 20 according to specific variables either standardized by Car Hire rules or specifically negotiated between the owner and the railroad, or two interchanging railroads. Calculation of both of these amounts by the respective modules 18 and 20 will be discussed in more detail later in this specification. The initial car hire module 18 and the reclaims module 20 provide and/or update information in a payables data generation module 22 which is preferably capable of generating reports sent to both respective customers 16 and Railinc 12 to satisfy the customer's reporting obligation.

The payables system 10 described in this specification has many advantages over existing car hire payables systems. First, the car hire payables system 10 is capable of applying more than one reclaim to a single possession. Second, the payables system 10 does not rely upon a customer manually entering a reclaim code concurrent with a possession to which the reclaim applies, but instead automatically applies reclaims using a novel reclaim queue that selects a combination of reclaims calculated as most cost-beneficial to the railroad customer. Each of these features provide substantial monetary benefits to railroads using transport equipment owned by others. Moreover, the payables system 10 is capable of generating reports daily, giving customers a month-to-date balance from which the customer can estimate an anticipated month end balance owed for planning purposes. Finally the payables system 10 automatically provides RailInc with a customer's car hire data, satisfying that customer's reporting obligation. Preferably, the reports communicate the net amount a customer owes after application of applicable reclaims. Alternatively, the reports can simply report the reclaim amounts so that a customer and/or RailInc can deduct those amounts from car hire owed an owner. Alternatively still, the reports or amounts contained therein may be communicated to the customer through RailInc or vice versa.

Referring specifically to FIGS. 1 and 3, the initial car hire computation module 18 gathers rate information 30 and possession information 32 from which an initial car hire amount can be computed. Rate information 30 may be gathered from CHARM, which contains default and negotiated rate information, customer contracts, a TTX rate card, tariffs, or any other source from which a relevant time and/or mileage rate may be applied to a possession. CHARM and TTX rate card information is typically accessible electronically over a network connection such as the Internet, while the other information may be accessible either through a network connection with the applicable customer or third party, or alternately stored on a server within or connected to the payables system 10. The payables system 10 preferably gathers rate information from as many sources as possible so that the most applicable rate may be selected. For example, though time and mileage rate information from CHARM for a piece of equipment may be available, the particular customer may have a contract that specifies a different, negotiated rate between the customer and the owner of equipment for which an initial car hire amount is being calculated. By accessing sources of information besides CHARM, the payables system 10 is capable of applying more accurate time and mileage rates.

Similarly, the possession information 32 is preferably compiled from as many sources as possible, such as the LCS system, customer waybills, and customer Train Operating Systems (TOS). Because the possession information from LCS may have been inferred after one or both parties to an interchange fail to report the interchange, the LCS data may result in excess liability. The additional information may then be used by the payables system 10 to more accurately calculate the time and mileage of the possession. Using the applicable rate information 30 and possession information 32, the initial car hire computation module 18 calculates an initial car hire amount, then forwards calculated amounts to the payables data generation module 26. These amounts may then be modified by the reclaims calculation module 20.

Referring to FIG. 4, the reclaims calculation module may include a novel reclaims queue, which in the described embodiment includes all reclaims for which a customer is potentially eligible during an accounting month. Each reclaim is given a unique code and is associated with particular parameters, each of which is required to activate the reclaim. Further, each reclaim is given a priority, with car hire rule reclaims receiving the highest priority. For example, a particular customer may have negotiated a reduced mileage rate for cars owned by X and carrying grain. The parameters associated with this reclaim would be the customer's railroad identifier, the owner's identifier, and an identifier indicating that the cargo is grain. Preferably, each of the parameters are indicated by codes that match those gathered from the inputs 12, 14, and 16. Thus, the parameter for the railroad identifier could be the railroad's SCAC obtained from the MARK IRF, or a customer's waybill, etc., while the parameter for the owner could be the first four letters of the equipment mark, and the parameter for grain could be the seven-digit transportation commodity code. In this manner, once all potential reclaims are compiled in the queue, applicable reclaims may be directly matched to particular possessions using the data available to the payables system 10.

The reclaim queue 34 permits the payables system 10 to provide substantial advantages to customers relative to existing payables systems. First, existing systems require a railroad to manually enter a reclaim code concurrent with a possession being reported to RailInc. This exposes the railroad to two types of costs eliminated by the present system. First, manual entry is prone to error, either by omitting a reclaim code or entering the wrong code, resulting in the reclaim being vacated. By automatically applying reclaims, the payables system 10 avoids such manual errors. Second, and perhaps more importantly, railroad operators may not know, at the time the reclaim code is entered, which reclaim is most beneficial. For example, an operator may apply an “up to” reclaim to a piece of equipment for free use during the first 120 hours of the month, only to later have that equipment held short of a loading point, or break during use requiring repairs. In hindsight, it would have been better to apply a “fixed time” reclaim to the equipment, and then use the “up to” reclaim for the remaining time. The present system, conversely, is capable of updating reclaims on a daily basis so as to maximize the amount of reclaims for which a customer is eligible. A further feature of the disclosed payables system 10 is to generate reports that let customers know, each month, how much money they saved by using the codes entered into the TRAIN II database to compare the reclaims calculated by the LCS system and the payables system 10. It is estimated that a typical customer saves 10-12% using the disclosed payables system 10.

The disclosed payables system 10, using the reclaims queue, achieves yet additional computational accuracy relative to existing systems. Referring to FIGS. 5-9, the reclaims computation module 20 in step 40 undergoes a preliminary processing step 40, in which payables records are created 50 using data inputs from the customer. Payables records preferably include reports for each owner whose equipment the customer used in the accounting month, each report itemizing the equipment used, the net amount owed for the equipment, along with the computational data employed, such as the possessions, the mileage and tile per possession, etc. These reports may then be sent to the customer and RailInc. Once payables records are created, the preliminary processing step 40 collects information in step 52 from the assorted inputs 12, 14, and 16 that are needed to assess the applicability in the current accounting month of potential reclaims of a customer that are loaded into the queue 34 in step 54. Once the potential reclaims are loaded into the queue, the information obtained in step 52 is preliminarily used to deactivate any reclaims in the queue not applicable in the current accounting month. For example, if a particular potential reclaim is for a piece of equipment that the information of step 52 shows as not being used by the customer during the month (zero time), that reclaim will be deactivated before the reclaim queue is processed by the further steps 42, 44, and 46 shown in FIG. 5.

After deactivation of reclaims inapplicable to the accounting month, the reclaim queue 34 is used to apply reclaims to particular equipment/possession combinations as shown in FIGS. 7-9. The rate reclaim selection step 60 will analyze, in sequence, each equipment/possession combination and apply the most favorable rate reclaim for the respective combination in step 64. In the disclosed system, only one rate reclaim is allowed per cycle and that reclaim must be for the entire cycle. In other alternate systems, multiple rate reclaims may apply during a possession where rate reclaims are divided among different portions of the possession, e.g. if a customer possessed a car for an entire month, transports grain eligible for one rate reclaim during the first half of the month and is still eligible for a lesser negotiated rate reclaim during the remainder of the month due to, for example, the type of car.

In step 66, if a rate reclaim is applied to a piece of equipment for a possession, any rate reclaim applied in a previous day in the accounting month is reversed and the remainder of the rate reclaims for that piece of equipment will be deactivated. (It should be understood that this deactivation will have no effect on reclaims for other pieces of equipment because each reclaim is associated with parameters, each of which must be present for the reclaim to be applicable. Thus, if a particular owner grants a reclaim applicable to more then one piece of equipment used during the relevant accounting month, the queue will include an individually corresponding reclaim for each piece of equipment.)

In step 68, if a rate reclaim has been applied at step 64, any “fixed time” and “up to” reclaims previously applied to the equipment is reversed in the payables records created in step 50, and in step 70, all potential such “fixed time” and “up to” reclaims in the queue, which may have been deactivated in a prior day's processing, are reactivated. These two steps allow the recalculation of the most beneficial time reclaims in light of the newly applied rate reclaim. For example, a rate reclaim may be based on a commodity such as coal. The waybill showing that the commodity is coal may not be received immediately, in which case a higher default CHARM rate along with a standard “up to” reclaim using the default rate are applied on that first day. The following day the waybill may arrive showing the coal commodity, so the reclaim from the previous day is reversed, the reclaim for lower rate is applied, and the “up to” claim is reapplied against the lower net value.

Once steps 70 and 72 are completed, any newly added rate reclaim is added to the applicable payables record created in step 50 and at a decision step 74, either more reclaims are evaluated if any are left in the queue for other equipment, or processing proceeds to the step 44 of applying applicable fixed time reclaims to equipment used by the customer. Referring specifically to FIG. 8, any “fixed time” reclaims in the queue are extracted in step 76 and duplicates are deactivated in step 78. In order to apply fixed time reclaims in the most cost-effective manner, potential reclaims for each piece of equipment are first sorted in steps 80-84. As stated previously, fixed time reclaims typically negate all care hire amounts during the fixed time intervals between which certain circumstances have occurred, such as a car being held short of loading, or a car being repaired. To facilitate efficient association of all available fixed time reclaims with used equipment, the use of each piece of equipment is divided into “cycles” which are logical contiguous groupings of equipment movements and non-movement events, such as loading/unloading, repair, etc. For example, one cycle might include an empty railcar being moved to a loading location, then being held short of that location for a specified duration, and a subsequent cycle might include the car being loaded and moved to a destination.

In step 80, potential reclaims for a particular car/cycle combination are selected and first sorted in step 82 by of precedence of the reclaim party. In the system described in this disclosure, that precedence is (1) reclaims specifically forced as highest priority (2) reclaims against the owner of the equipment and (3) reclaims against a third party, such as the railroad that delivered the equipment to the customer at an interchange. Then in step 84, within each party precedence, reclaims are further sorted in order of (i) reclaims against the full possession of the equipment (ii) reclaims against a full cycle; and (iii) reclaims against a partial cycle. Once sorted, the highest priority reclaim is selected against the equipment in step 86, and added to the payables records in step 88. At decision step 90, if there is time left in the cycle (which means that some car hire is still owed for that equipment/cycle combination), then the reclaim with the next highest priority is evaluated until either all the time in the cycle is accounted for or no more fixed time reclaims apply to the particular equipment/cycle combination. At decision step 90, if the queue contains additional fixed time reclaims (which must, by the time that step is reached, apply to one or more different equipment/cycle combinations than those previously evaluated), then the next equipment/cycle combination is evaluated, else processing proceeds to the “up to” reclaims processing module 46.

The process described in the preceding paragraph assures that the maximum possible value of the available “fixed time” reclaims will be applied to each cycle for a particular piece of equipment. Assume, for example, that a cycle for a piece of equipment includes transferring an empty hopper car to a loading point where it waits six hours to be loaded with coal at which point the cycle ends. One potential “fixed time” reclaim may be for time spent while empty while another potential “fixed time reclaim” is for the six-hour waiting period, both applied against an owner. The ordering process will apply the former reclaim first, which applies to the entire cycle at which is the maximum possible (zeroed out) reclaim for that cycle. Assume, alternatively, that a railroad has placed the equipment at the loading location, where it sits for six hours and then is loaded with coal and moves to a destination for unloading. In route, the car is damaged and the railroad agrees to immediately buy it, at which point any subsequent time and mileage are allowed a reclaim. If the cycle is defined as including this entire period, then neither reclaim applies to either the entire possession or the entire cycle. One will be selected first, then, because time is still remaining in the cycle, the next will be selected and applied.

Referring to FIG. 9, once all applicable “fixed time” reclaims have been applied to each piece of transport equipment, processing proceeds to apply any applicable “up to” reclaims by first extracting, in step 94, all potential “up to” reclaims for the customer, again deactivating duplicates at step 96. At steps 98 and 100, similar to the procedure for applying “fixed time” reclaims, the “up to” reclaims in the queue are sorted and applied in equipment/cycle combinations with reclaims for each combination prioritized by forced reclaims, reclaims against the owner, and reclaims against a third party. Once a particular equipment/cycle is selected in step 98 with its reclaims prioritized in step 100, step 102 deactivates any “up to” reclaim for which all the time has been previously applied to other equipment/cycle combinations. The next “up-to” reclaim still active is applied to the equipment/cycle combination at step 104, and added to the payables record at step 106. If there is still time left on the “up to” reclaim, the next car/cycle combination is selected and processed. This entire procedure is repeated at decision step 110 so long as more “up to” reclaims are left in the queue.

Preferably, the equipment/cycle combinations are prioritized by the rate applied to the equipment so that “up to” reclaims will first be applied to equipment that has the highest rate, saving the customer the most money. More preferably, the rates are compared after being adjusted by the rate reclaim module 42, so that even where two pieces of equipment have the same default rate in CHARM, the “up to” reclaim will be first applied to equipment that has either not been discounted, or discounted less than the other piece.

Also, each potential “up to” reclaim may optionally include a flag that indicates whether it is “exclusive” or “inclusive.” An “exclusive” flag means that it can only be taken against the particular party being reclaimed while an “inclusive” flag means that it can be taken against any party. Because inclusive “up to” reclaims can be applied across multiple owners, they are more likely to be fully utilized. Conversely, to fully utilize exclusive “up to” reclaims, the system 10 preferably “wraps” them, if possible, around a “fixed time” reclaim on the same piece of equipment. Assume, for example, that a railroad negotiated an “up to” reclaim with a particular owner for a railroad car being used to transport automobiles. In the middle of the possession, the car was eligible for a “fixed time” reclaim, which was applied. When the system 10 begins to process the “up to” reclaim for that piece of equipment, it may first apply the reclaim to the beginning portion of the cycle, prior to the “fixed time reclaim” negating any car hire owed. Then, if there remains any time left on the “up to” reclaim, it is applied from a point beginning at the end of the “fixed time” reclaim. In this manner, should that piece of equipment be the only one used by the particular owner for which the “up to” reclaim is allowed in the accounting month, it will be used to the fullest extent possible.

Another distinguishing feature of the system 10 is that it is capable of taking the last part of a possession for an “up to” reclaim rather than the first part of that possession. One situation in which this would be more beneficial is an outbound switching reclaim from release loaded to interchanged offline against the interchanging railroad in lieu of using a Transfer of Liability.

A further distinguishing feature of the system 10 is that reclaims are taken in the months for which they apply. The existing systems for calculating car hire will wait until a possession is complete before applying a reclaim. Thus, in those existing systems, where a possession occurs over consecutive months, but the reclaim applies during the first month, the railroad must first pay the full amount of car hire for the portion of the possession in the first month, but then be credited for the reclaim in the second month. The currently disclosed system 10, however, allows railroad customers to immediately realize the benefits of their reclaims.

Finally, the currently disclosed system allows a reclaim against a cycle to be manually entered using user interface. That reclaim trumps all other reclaims as the highest priority reclaim unless the manually entered reclaim is invalidated by subsequently obtained information. If the manually entered reclaim is invalidated, the client is notified of such invalidation so that appropriate action may be taken.

As noted earlier, one of the complexities of calculating car hire is that the various business entities involved will negotiate special agreements. These may be as simple as the rail car owner agreeing to a special rate for cars used to service a particular customer. More frequently, interchanging railroads may agree to pay a portion of the car hire for another railroad by offering a reclaim. It is common for a small railroad to have certain car hire paid by a larger railroad feeding the car to them. This is typically something like “up to 120 hours of the time you have the car” or “from the time I give you the car empty until the time that the customer has loaded it.” In the actual administration of the reclaims, again as discussed earlier, the total amount due the owner is paid to the owner, but the reclaims are recovered from the interchanging railroad.

Car hire can be a significant expense for a railroad and one which railroads desire to actively understand and manage. Previous efforts have focused on presenting information to the railroad in such a manner as to enable ascertaining that they are receiving the correct reclaim(s) across the possession of the car. However, true management requires a clear understanding of what is influencing car hire expense.

In order to determine in a useful manner what is affecting car hire, it is necessary to determine the total time the car is being used to service the delivery of the load to or from a customer, and then break down that time into operational components, e.g. components that measure the efficiency of the railroad in using the car such as the time it took to move a car to a customer, the time it takes to load the car, or to move the car from the customer off of the railroad's lines etc. At first blush, it might seem that simply looking at these operational components would indicate how to better manage car hire expense. While in the most simplistic of cases this might be true, railroad operation is rarely simplistic and mere analysis of operational components would likely badly distort the effect that those operational components truly have on car hire.

One complicating factor relates to the cost of operation component, which is dependent upon the relationship with the business agreements affecting car hire. A simple example is if the railroad does not have to pay car hire from the time the car is received until it is placed at the customer. In this case, the amount of car hire does not vary at all depending on the efficiency of moving the car to the customer, even if it takes a year or longer. On the other hand, if the railroad gets up to 120 hours of car hire relief and uses the car for longer than 120 hours, then a one hour change in any of the operational components will directly increase car hire by one hour. Thus, since any operational component can affect car hire in this example, it would not lead to an accurate analysis if the first 120 hours were always treated as cost free. Any efficiencies to be gained may well be during the first 120 hours and visibility of that is lost.

The second influence is the Liability Continuity System (LCS). Railroads are required to report rail car interchanges with another railroad to RailInc, the central reporting entity for railroads. Because both parties in an interchange could report different times, RailInc issues LCS messages dictating the official time of the railroads' time of car hire liability and railroads must pay owners based upon those LCS messages, regardless of the actual interchange time. Thus, the time at which payment begins and ends may differ from the actual time a railroad receives and/or released a car. In order to adequately present the influence of LCS on car hire cost, it must not alter the time or cost of any operational component. For instance, the time from receipt of the car until it is placed at the customer should not be adjusted by an increase or decrease in cost due to LCS differences.

LCS can also assign or alleviate additional periods of liability that have no relationship to the railroad actually interchanging the car. These LCS gaps thus affect car hire but must be measured separately from the actual handling time of the car.

In a similar manner, the car hire rules allow under specific conditions for the transfer of liability (TOL) to another railroad for the performance of rail car switching services. Like LCS, these can increase or decrease the amount of car hire actually paid to the car owner, but should not affect the analysis of the operational components of handling the rail car.

The third influence is how the car is actually being used. If one simply presents all the loads for a given customer without regard to any classification of the load, changing traffic patterns may seem to affect month-by-month trending of car hire costs, when it is really a different type of load instead of changes in operational efficiencies. Examples of this might be a car received empty for loading by a customer, a car received with a load for a customer, a car already on the railroad and used for loading by the customer, a car load for a customer that originated by another customer on the same railroad, and a car sent to the customer for loading with the load intended for another customer on the same railroad.

FIG. 10 generally illustrates a system 200 that automatically processes car hire information, including reclaims, along with LCS data to determine the influence on car hire costs of specific operational components. Preferably, the system 200 includes a processor 210 operatively connected to a local database 220 and a remote database 230 from which LCS data may be selectively retrieved. In some embodiments, the LCS data may be periodically downloaded and stored in local database 220, or in other embodiments LCS information may be retrieved from database 230 as needed. The processor 210 is also preferably connected to one or more input devices 240 such as a mouse and a keyboard as well as output devices such as a display 250 and a printer 260. In some embodiments, the system 200 may be integrated with the system 10 described earlier, meaning that the a processing device that receives LCS and car hire information to automatically calculate reclaim amounts owed may also perform the functionality described with respect to FIGS. 10 and 11.

Referring specifically to FIG. 11, the processing device 210 preferably receives inputs from the local and remote databases 220 and 230 in step 300. In step 310, the processing device 210 preferably determines the boundaries of the possession of a particular car (or other piece of railroad equipment) for which car hire is due in step 310. This information may be determined by analyzing LCS continuity data, from customer waybills and other interchange information stored in the local database 220, etc. The system 200 may in some embodiments store any discrepancies between these sources of information.

In step 320, each load within the possession is classified. The classification of a “load” refers not to the content of a load, e.g. coal or timber, etc. but instead more generically to a description of statistics of a given load's movements on a railroad's line. The term “load” itself refers to the cargo carried by a car, without regard to any individual characteristics of the cargo, between loading and unloading times, and between unloading and loading times (thus, an empty car is a “load.”) The load may preferably be classified into any of the following categories:

1. IB Single—used to describe a load that entered a railroad's line and was emptied on the line and not reloaded;

2. OB single—used to describe a load that entered a railroad's line empty and was loaded on the line;

3. IB multiple—used to describe a load that entered a railroad's line and was emptied on the line and reloaded;

4. OB multiple—used to describe a load that was the final load on a car and delivered off the line loaded;

5. Line Haul—used to describe a load that was loaded and unloaded while remaining on the road;

6. Bridge—used to describe a car that was received and delivered without being loaded or unloaded, i.e. the car was just moving empty or loaded over a rail's line without loading or unloading;

7. Shop—used to describe a car that was sent to the road for delivery to a shop for repairs;

8. Storage—used to describe a load that was sent to the road for storage;

9. Terminated—used to describe a load that ended by something other than delivery, such as a derailment;

10. LCS error—used to describe a load with liability from a reporting error. This typically occurs when a customer never received a car, but LCS data indicates that the customer did;

11. Aborted—used to describe a car that was placed but ultimately not used;

12. Partial—used to describe a situation when it is yet unknown what category the load falls into;

13. Unclassified.

It should be understood that this listing is for illustrative purposes only, and is not an exhaustive list of the categories into which a load could be classified.

In step 315, the number of hours, miles, and gross car hire reported is determined for each load. A net cost for servicing that customer with a load is determined by deducting all reclaims taken during the time of that load.

In step 330, the load, for its given classification, is broken down into operational components (and the time of each operational component) based on the movement events reported by the railroad. Operational components could include:

1. Move from receipt—from receipt until the next event, e.g. place with a customer, in storage, etc;

2. Reposition—from customer release or hold release until the next placement or hold;

3. PCON—In constructive placement, i.e. the load was attempted to be placed, but hasn't been used yet;

4. Move to delivery—Movement from last event to delivery;

5. Bad order—time that a car is broken;

6. Storage—time in storage;

7. Embargo—time in embargo, Examples would be a bridge out, etc;

8. Unclassified.

Again, this listing is for illustrative purposes and is not intended to be an exhaustive list of the types of operational components that one skilled in the art could analyze.

Once the operational components of the load have been determined and classified, the road's operational components are augmented in step 340, if desired. For example, a road's operational components could be augmented with additional components helpful for breaking down the effect that LCS had on car hire, such as the difference between LCS and the road's reported receipt, the difference between LCS and the road's reported delivery, a gap in car hire due to an LCS reporting of SHOP or other periods with no liability, or a gap in car hire due to an LCS gap in possession. As another example, operational components could be augmented with components for a TTX owned car on a TTX member road given that intra-TTX members agree that TTX reporting of exchanges overrides LCS data. Examples of these augmented components include the difference between a road reported receipt (or delivery) from TTX data or non-member time assigned by TTX. Still another example of operational components being augmented is for the effects of Transfer's of Liability (TOLs) due to car hire rules, e.g. car hire rule 15 (TOL taken—or received—for a switch performed by another road), car hire rule 15 TOL taken—or received—for a car not accepted when offered.

In step 350, the gross financial value of each operational component, including the augmented components is calculated by reversing specified reclaim amounts. In one embodiment, reclaim amounts deducted include only those reclaims that by their terms can apply only to the time in that component (within its hierarchical level, meaning within the non-augmented category of operational components, etc.) Stated differently, no reclaim is deducted in this step if it could apply over more than one operational component within its hierarchical category.

In step 360, and additional “other reclaims” component is generated which sums all reclaims not fixed to specific components. This would include “up to” reclaims that can be applied to any time during the load and fixed amount incentive or penalty reclaims.

In step 370, all calculations are stored for analysis by generalized query tools as will as use by certain fixed-format reports that can be displayed or printed.

The terms and expressions that have been employed in the foregoing specification are used therein as terms of description and not of limitation, and there is no intention, in the use of such terms and expressions, of excluding equivalents of the features shown and described or portions thereof, it being recognized that the scope of the invention is defined and limited only the claims that follow.

1. A system comprising:
(a) storage that stores statistical data for at least one possession of a unit of railroad transport equipment for which car hire is owed;
(b) a processor that analyzes said statistical data to determine the effect on said car hire of at least one operational component.

2. The system of claim 1 where said statistical data includes data quantifying boundaries of said possession, said boundaries being at least one of time and distance.

3. The system of claim 2 where at least some if said statistical data is LCS data.

4. The system of claim 1 where said processor determines said effect by classifying said at least one possession into at least one type of load carried by said unit of railroad transport equipment, where said type of load is independent of any characteristics of cargo carried by said unit of railroad transport equipment during said possession.

5. The system of claim 4 where each said at least one type of load is classified into said at least one operational component.

6. The system of claim 1 where said processor determines the effect on said car hire of at least one operational component by reversing a reclaim against said car hire from a financial value of said at least one operational component.

7. The system of claim 1 including a database of effects on said car hire of said at least one operational component, where said database can be queried by a user.

8. The system of claim 1 where said processor analyzes said statistical data to determine the effect on said car hire of gaps in LCS data.

9. The system of claim 1 where said processor analyzes said statistical data to determine the effect on said car hire of a transfer of liability.

10. A system comprising:
(a) storage that stores statistical data for at least one possession of a unit of railroad transport equipment, for which an amount of car hire is owed;
(b) a processor that uses said statistical data to calculate a reclaim against said car hire, and said processor determines the effect on said car hire of at least one operational component of said at least one possession by reversing said reclaim against said car hire.
